(19) United States
(12) Patent Application Publication
(10) Pub. No.: US 2024/0110479 A1
(43) Pub. Date: Apr. 4, 2024

(54) MULTI-FACTOR QUANTITATIVE ANALYSIS METHOD FOR DEFORMATION OF NEIGHBORHOOD TUNNEL

(71) Applicant: Qingdao University of Technology, Qingdao City (CN)

(72) Inventors: Yongjun ZHANG, Qingdao City (CN); Fei LIU, Qingdao City (CN); Sijia LIU, Qingdao City (CN); Junyi WANG, Qingdao City (CN); Bin GONG, Qingdao City (CN); Yingming WU, Qingdao City (CN); Ruiquan LU, Qingdao City (CN); Qingsong WANG, Qingdao City (CN); Qinghui XU, Qingdao City (CN); Xiaoming GUAN, Qingdao City (CN); Mingdong YAN, Qingdao City (CN); Xiangyang NI, Qingdao City (CN); Pingan WANG, Qingdao City (CN); Shuguang LI, Qingdao City (CN); Lin YANG, Qingdao City (CN); Ning NAN, Qingdao City (CN); Dengfeng YANG, Qingdao City (CN)

(21) Appl. No.: 18/172,775

(22) Filed: Feb. 22, 2023

(30) Foreign Application Priority Data
Sep. 30, 2022 (CN) 202211208063.7

(51) Int. Cl. E21F 17/18

(52) U.S. Cl. CPC E21F 17/18; E21D 9/00

(57) ABSTRACT

The present disclosure provides a multi-factor quantitative analysis method for deformation of a neighborhood tunnel. The method includes the following steps: analyzing monitoring data generated at a tunnel site; simulating collapse occurring at a shallow buried section of a tunnel; determining the degree of influence of each factor on the tunnel and a stratum; and determining quantitative influence of each factor on tunnel deformation. The present disclosure can not only provide an accurate theoretical basis for the construction of the shallow buried section of the small-distance tunnel, but also guarantee safety and cost saving during tunnel construction.

### CROSS REFERENCE TO RELATED APPLICATION

This patent application claims the benefit and priority of Chinese Patent Application No. 202211208063.7, filed with the China National Intellectual Property Administration on Sep. 30, 2022, the disclosure of which is incorporated by reference herein in its entirety as part of the present application.

### TECHNICAL FIELD

The present disclosure relates to the technical field of tunnel construction, and in particular to a multi-factor quantitative analysis method for deformation of a neighborhood tunnel.

### BACKGROUND

China is ranked the third on a list of countries with the largest area, with a total area up to 9.6 million square kilometers. The country stretches across the East Asian landmass in an erratically changing configuration of broad plain, plateaus, hills and mountain land, of which the mountainous area accounts for 33%, making it difficult to achieve infrastructure construction. As an important part of China's transportation network, expressway is essential for realizing traffic modernization and national modernization and accelerating the economic and social development of China. In expressway construction, the number and total length of tunnels as an important part of traffic lines are also increasing year by year.

Given the constraints of geological conditions, topography, route selection requirements and other objective conditions, as well as limiting factors such as construction technology and engineering cost, small-distance tunnels have been commonly used in highway engineering. However, compared with traditional tunnel types, small-distance tunnels are prone to collapse or other geological disasters during construction in the shallow buried area of the tunnel because of its complex stress and susceptibility to eccentric compression in the mountain area. Therefore, the study of the surrounding rock deformation pattern and excavation response of the small-distance tunnel in the shallow buried section is of great significance to the tunnel construction.

At present, many research methods for deformation of small-distance tunnels have been proposed to study the deformation mechanism and surrounding rock response pattern of small-distance tunnels from different aspects, which have achieved valuable results, and promoted the determination of the mechanical mechanism of the small-distance tunnel and the reasonable working procedure during construction. However, there are few research findings on the engineering geology disasters and accidents of the small-distance tunnel, and the disaster evolution mechanism and the law of response of various factors to the tunnel are yet to be studied. This results in the lack of key indexes of the influence factors of the small-distance tunnel, and thus an accurate theoretical foundation cannot be provided for the construction of the shallow buried section of the small-distance tunnel, making it impossible to guarantee safety and cost saving during tunnel construction. In view of this, the present disclosure provides a multi-factor quantitative analysis method for deformation of neighborhood tunnel, so as to solve the problems existing in the prior art.

### SUMMARY

In view of the foregoing problems, an objective of the present disclosure is to provide a multi-factor quantitative analysis method for deformation of a neighborhood tunnel, so as to solve the problems with existing research methods for deformation of a small-distance tunnel that a disaster evolution mechanism is not explored yet, and thus key indexes of the influence factors of the small-distance tunnel are not available.

In order to achieve the above objective, the present disclosure is implemented through the following technical solution: the present disclosure provides a multi-factor quantitative analysis method for deformation of a neighborhood tunnel, where the method includes the following steps:
step 1: making a theoretical analysis of surrounding rock pressure on a tunnel to be analyzed, monitoring a tunnel site in combination with tunnel design data, and collecting, analyzing, concluding and summarizing monitoring data of the tunnel site;
step 2: taking collapse of a shallow buried section of the tunnel as a starting point, analyzing causes of the collapse in combination with the summarized monitoring data at the tunnel site and a theory of tunnel deformation to determine main causes of the tunnel collapse, simulating the collapse leading straight to a ground surface during tunnel construction by using finite element numerical simulation software, extracting numerical simulation results to obtain deformation characteristics in the process of tunnel construction, and analyzing tunnel displacement fields of different distances within a period from tunnel excavation to tunnel collapse to determine a displacement and a stress response generated when tunnel collapse occurs;
step 3: according to the displacement and the stress response generated when the tunnel collapse occurs, analyzing factors affecting tunnel deformation and surrounding rock instability according to a control variate method to obtain a mechanism of deformation responses of a stratum and a tunnel to various factors, fitting deformation caused by the factors based on the data, and determining the degree of influence of each factor on the tunnel and the stratum; and
step 4: conducting, based on the extracted numerical simulation results and the degree of influence of each factor on the tunnel and the stratum, deformation-related quantitative calculation on factors affecting the tunnel deformation using a statistical analysis method of grey relational analysis-entropy evaluation method, sorting a relevancy degree of each factor to the deformation of the shallow buried unsymmetrical loading tunnel section of the tunnel to obtain main influence factors in tunnel deformation, and determining quantitative influence of each factor on tunnel deformation.

As a further improvement of the present disclosure, in step 1, the monitoring content at the tunnel site includes required monitoring items and optional monitoring items, the required monitoring items include observation inside and outside a tunnel, ground surface settlement, vault settlement and horizontal convergence during tunnel construction, and the optional monitoring items include internal force measurement for a steel arch, a seepage pressure, a surrounding rock pressure of the tunnel and axial force of an anchor bolt.

As a further improvement of the present disclosure, in step 1, when the monitoring data of the tunnel site are collected, analyzed, concluded and summarized, based on an advanced geological forecast, proportions of surrounding rock at grade III, surrounding rock at grade IV and surrounding rock at grade V at a tunnel face are determined, and mechanism summarization and characteristic analysis are conducted with tunnel deformation data of the surrounding rock at different grades to determine different deformation stages of surrounding rock of a tunnel.

As a further improvement of the present disclosure, the deformation stages of surrounding rock of a tunnel are classified into a growth stage and a stabilization stage, and the growth stage is divided into a rapid growth stage and a slow growth stage.

As a further improvement of the present disclosure, in step 2, a whole process of tunnel construction is reproduced using the finite element numerical simulation software, three-dimensional inversion of a collapse accident occurring during tunnel construction is carried out, and in combination with data simulation and cause analysis, a whole process of tunnel deformation and surrounding rock failure accompanying the tunnel collapse is determined.

As a further improvement of the present disclosure, in step 3, the factors affecting tunnel deformation and surrounding rock instability include an over-excavation height, a displacement distance of a face and an elastic modulus of surrounding rock, and different gradients are set for the over-excavation height, the displacement distance of a face and the elastic modulus of surrounding rock when analysis is conducted according to a control variate method.

As a further improvement of the present disclosure, in step 3, said determining the degree of influence of each factor on the tunnel and the stratum specifically includes taking ground surface settlement, a middle rock wall between the neighborhood tunnel and tunnel deformation as a judgment basis, obtaining deformation curves under different working conditions, extracting and summarizing data of ground surface deformation and tunnel deformation to obtain rules of responses of different factors to the tunnel and stratum, and obtaining characteristic values of each factor.

As a further improvement of the present disclosure, in step 4, said conducting deformation-related quantitative calculation specifically includes taking tunnel vault deformation and horizontal convergence as a judgment basis, calculating to obtain a relevancy degree of each factor to the tunnel deformation, and sorting the relevancy degree in a descending order.

The present disclosure has the following beneficial effects: by taking collapse of a shallow buried section of the tunnel as a starting point, and monitoring data at a tunnel site and finite element modeling as an analysis means, the mechanism of ground surface settlement and tunnel deformation in the process of tunnel excavation is analyzed, and the collapse occurring in the shallow buried section is determined, such that the causes of the collapse accident are determined, and on this basis, the relevancy degree of each factor to the tunnel deformation is obtained; meanwhile, the influence of different factors on tunnel deformation is analyzed according to a control variate method, and deformation-related quantitative analysis is conducted for each factor by a grey relational analysis-entropy evaluation method, and key indexes of the influence factors of the small-distance tunnel are obtained, which can not only provide an accurate theoretical basis for the construction of the shallow buried section of the small-distance tunnel, but also guarantee safety and cost saving during tunnel construction.

### BRIEF DESCRIPTION OF THE DRAWINGS

To describe the technical solutions in the embodiments of the present disclosure or in the prior art more clearly, the accompanying drawings required for describing the embodiments or the prior art will be described briefly below. Apparently, the accompanying drawings in the following description show some embodiments of the present disclosure, and a person of ordinary skill in the art may still derive other drawings from these accompanying drawings without creative efforts.

FIG. 1 is a flowchart of a method according to the present disclosure;

FIG. 2 is a schematic diagram of tunnel monitoring points according to an embodiment of the present disclosure;

FIG. 3 is a schematic diagram of a ground surface monitoring point at the top of a tunnel entrance section according to an embodiment of the present disclosure; and

FIG. 4 is a comparison diagram of ground surface monitoring for a tunnel entrance according to an embodiment of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

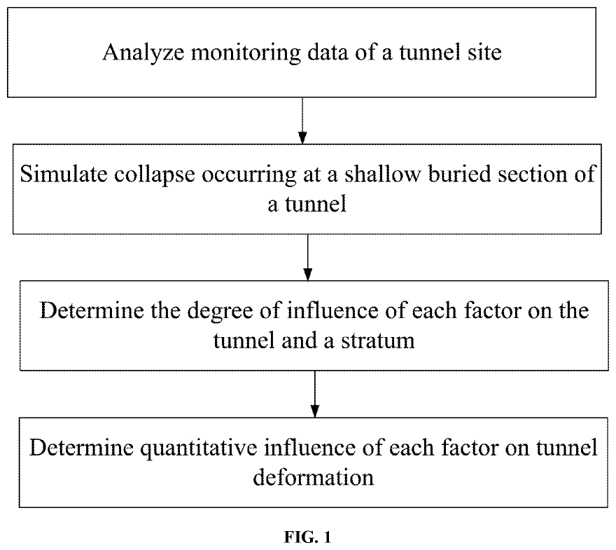

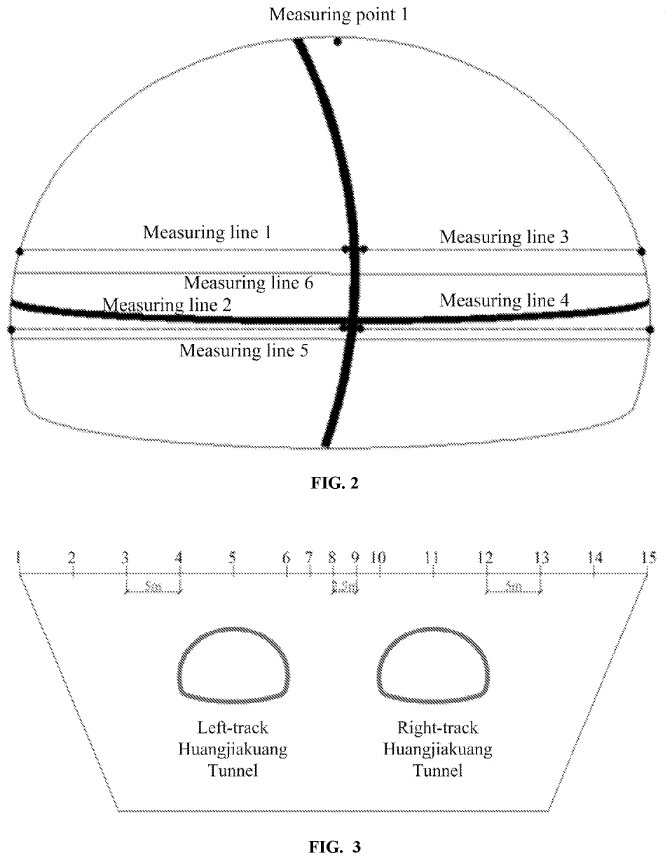

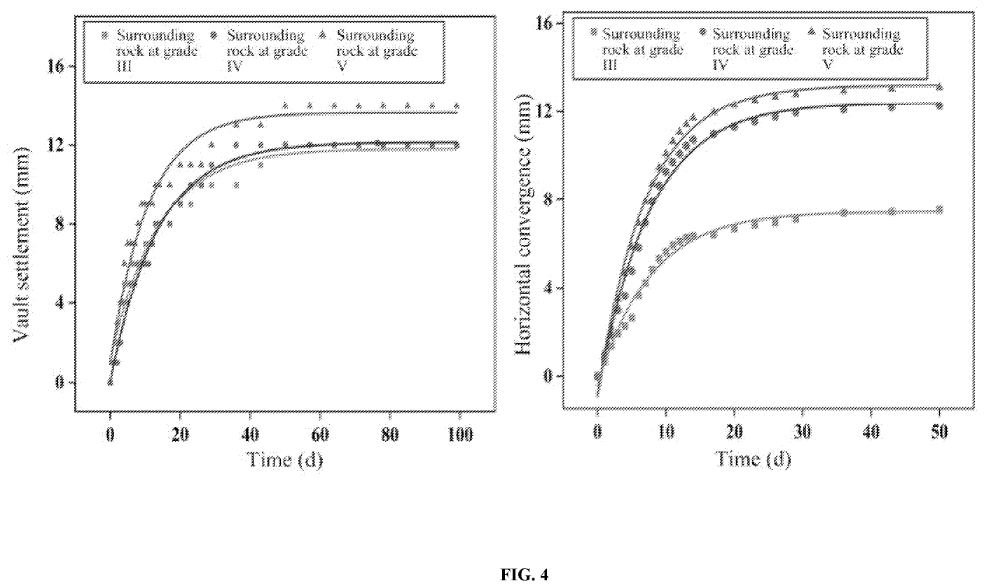

Referring to FIG. 1, FIG. 2, FIG. 3 and FIG. 4, this embodiment provides a multi-factor quantitative analysis method for deformation of a neighborhood tunnel, the method including the following steps:

Step 1: Select Huangjiakuang Tunnel in Weihai City, Shandong Province as a research object, make a theoretical analysis of surrounding rock pressure on the tunnel, and present a targeted monitoring scheme in combination tunnel design data to monitor a tunnel site, where the monitoring content at the tunnel site includes required monitoring items and optional monitoring items, the required monitoring items include observation inside and outside a tunnel, ground surface settlement, vault settlement and horizontal convergence during tunnel construction, and the optional monitoring items include internal force measurement for a steel arch, a seepage pressure, a surrounding rock pressure of the tunnel and axial force of an anchor bolt; collect, analyze, conclude and summarize monitoring data of the tunnel site; based on an advanced geological forecast, determine that in the face area of Huangjiakuang Tunnel, surrounding rock at grade V accounts for a highest proportion, while surrounding rock at grade III and grade IV account for a relatively low proportion, and conduct mechanism summarization and characteristic analysis with tunnel deformation data of the surrounding rock at different grades to determine different deformation stages of surrounding rock of a tunnel, where it is determined that the surrounding rock deformation of Huangjiakuang Tunnel can be classified into a growth stage and a stabilization stage, and the growth stage is divided into a rapid growth stage and a slow growth stage, and tunnel deformation under surrounding rock at grade V is larger than that under surrounding rock at grade III and IV, and takes longer time to become stable; by comparing the difference of ground surface settlement at the tunnel entrance under different burial depths, it is determined that in the entrance section of Huangjiakuang Tunnel, the deformation of a small-distance excavated tunnel is greatly affected by the following tunnel, and the influence of the following tunnel on the advanced decreases gradually with the increase of the burial depth.

Step 2: Take collapse of a shallow buried section of the tunnel as a starting point, analyze causes of the collapse in combination with the summarized monitoring data at the tunnel site and a theory of tunnel deformation to determine excavation of a surrounding tunnel, properties of surrounding rock and over-excavation as main causes of the tunnel collapse, simulate the collapse leading straight to a ground surface during tunnel construction by using finite element numerical simulation software MIDAS GTS NX, extracting numerical simulation results to obtain deformation characteristics in the process of tunnel construction, reproduce a whole process of tunnel construction using the finite element numerical simulation software, carry out three-dimensional inversion of a collapse accident occurring during tunnel construction, determine a whole process of tunnel deformation and surrounding rock failure accompanying the tunnel collapse in combination with data simulation and cause analysis, and analyze tunnel displacement fields of different distances within a period from tunnel excavation to tunnel collapse to determine a displacement and a stress response (corresponding to the cause of the collapse determined by the analysis) generated when tunnel collapse occurs.

Step 3: According to the displacement and the stress response generated when the tunnel collapse occurs, set different gradients and conduct analysis according to a control variate method for factors affecting tunnel deformation and surrounding rock instability, such as the over-excavation height, the displacement distance of a face and the elastic modulus of surrounding rock, so as to obtain a mechanism of deformation responses of a stratum and a tunnel to various factors; fit deformation caused by the factors based on the data, and determine the degree of influence of each factor on the tunnel and the stratum, where said determine the degree of influence of each factor on the tunnel and the stratum specifically includes take ground surface settlement, a middle rock wall between the neighborhood tunnel and tunnel deformation as a judgment basis, obtain deformation curves under different working conditions, extract and summarize data of ground surface deformation and tunnel deformation to obtain rules of responses of different factors to the tunnel and stratum, and obtain characteristic values of each factor.

Step 4: Conduct, based on the extracted numerical simulation results and the degree of influence of each factor on the tunnel and the stratum, deformation-related quantitative calculation on factors affecting the tunnel deformation using a statistical analysis method of grey relational analysis-entropy evaluation method, sort a relevancy degree of each factor to the deformation of the shallow buried unsymmetrical loading tunnel section of the tunnel to obtain main influence factors in tunnel deformation, and determine quantitative influence of each factor on tunnel deformation, where said conduct deformation-related quantitative calculation specifically includes take tunnel vault deformation and horizontal convergence as a judgment basis, calculate to obtain a relevancy degree of each factor to the tunnel deformation, and sort the relevancy degree in a descending order.

Arrange a vault settlement monitoring point of Huangjiakuang Tunnel at the vault of the tunnel. Arrange different horizontal convergence measuring lines with a maximum of 6 according to different construction methods. FIG. 3 below is a schematic diagram of a monitoring point at Huangjiakuang Tunnel, including the vault settlement monitoring point and the horizontal convergence lines.

As shown in FIG. 4 below, a total of 15 ground surface monitoring points are set up at the top of the tunnel entrance section, of which the spacing for monitoring points 1-6 and monitoring points 10-15 is 5 m, and the spacing for monitoring points 6-10 is 2.5 m. Strip-shaped and cross-shaped observation nets are generally used to detect ground surface settlement, and observation points are arranged using steel nails and concrete piles.

The internal monitoring of Huangjiakuang Tunnel mainly includes vault settlement and horizontal convergence. The monitoring point is located right above the vault of the tunnel excavation section. According to the monitoring scheme, for the tunnel vault settlement, monitoring sections are arranged every 5 m, and there are 44 monitoring sections in the left-track tunnel, and 42 monitoring sections in the right-track tunnel. Considering that there are too many monitoring points, the vault settlement and horizontal convergence under surrounding rock at different grades are extracted, as shown in FIG. 4. According to the monitoring data, and as can be seen from FIG. 4, the tunnel deformation trends under the surrounding rock at three grades are roughly the same, and the curve runs similar to a logarithmic function, which goes through a process of rapidly increasing at first and then gradually becoming smooth. Therefore, the whole settlement process is divided into two stages. The first stage is the growth stage, and the second stage is the stabilization stage, in which the first stage is divided into the rapid growth stage and the slow growth stage.

In order to carry out tunnel construction in special sections, it is also necessary to supplement the optional monitoring items and comprehensively judge the stability of surrounding rock during construction. In the same time, an advanced geological forecast is used to grasp the geological conditions of the tunnel in front of the tunnel face. The required monitoring items and monitoring schemes in the process of tunnel construction are shown in Table 1 below.

TABLE 1
Required monitoring measurement items at a tunnel site

| | | Monitoring time interval | | | |
|---|---|---|---|---|---|
| Monitoring | Monitoring | | 16 days to 1 | | Longer than |
| content | tool | 1-15 days | month | 1-3 months | 3 months |
| Observation | Field | After excavation and the initial construction | | | |
| inside and | observation, | | | | |
| outside a | geological | | | | |
| tunnel | compass, etc. | | | | |
| Peripheral | Various types | 1-2 | Once/2 days | 1-2 | 1-3 |
| displacement | of convergence | times/day | | times/week | times/month |
| | gauges, total- | | | | |
| | station | | | | |
| | instruments, | | | | |
| | etc. | | | | |
| Vault | Level gauges, | 1-2 | Once/2 days | 1-2 | 1-3 |
| settlement | total-station | times/day | | times/week | times/month |
| | instruments | | | | |
| | and Invar | | | | |
| | rods | | | | |

| | | |
|---|---|---|
| Ground | — | When the distance between an excavation face and a |
| surface | | measured section is within a range of <2.5b before the |
| settlement | | excavation face reaches the measured section or after it |
| | | exceeds the measured section, monitoring shall be conducted |
| | | 1-2 times/day |
| | | When the distance between an excavation face and a |
| | | measured section is within a range of <5b before the |
| | | excavation face reaches the measured section or after it |
| | | exceeds the measured section, monitoring shall be conducted |
| | | 2-3 times/day |
| | | When the distance between an excavation face and a |
| | | measured section is within a range of ≥5b before the |
| | | excavation face reaches the measured section or after it |
| | | exceeds the measured section, monitoring shall be conducted |
| | | 2-3 times/day |

The above described are merely preferred embodiments of the present disclosure, and not intended to limit the present disclosure. Any modifications, equivalent replacements and improvements made within the spirit and principle of the present disclosure should all fall within the scope of protection of the present disclosure.

What is claimed is:

1. A multi-factor quantitative analysis method for deformation of a neighborhood tunnel, comprising the following steps:
step 1: making a theoretical analysis of surrounding rock pressure on a tunnel to be analyzed, monitoring a tunnel site in combination with tunnel design data, and collecting, analyzing, concluding and summarizing monitoring data of the tunnel site;
step 2: taking collapse of a shallow buried section of the tunnel as a starting point, analyzing causes of the collapse in combination with the summarized monitoring data at the tunnel site and a theory of tunnel deformation to determine main causes of the tunnel collapse, simulating the collapse leading straight to a ground surface during tunnel construction by using finite element numerical simulation software, extracting numerical simulation results to obtain deformation characteristics in the process of tunnel construction, and analyzing tunnel displacement fields of different distances within a period from tunnel excavation to tunnel collapse to determine a displacement and a stress response generated when tunnel collapse occurs;
step 3: according to the displacement and the stress response generated when the tunnel collapse occurs, analyzing factors affecting tunnel deformation and surrounding rock instability according to a control variate method to obtain a mechanism of deformation responses of a stratum and a tunnel to various factors, fitting deformation caused by the factors based on the data, and determining the degree of influence of each factor on the tunnel and the stratum; and
step 4: conducting, based on the extracted numerical simulation results and the degree of influence of each factor on the tunnel and the stratum, deformation-related quantitative calculation on factors affecting the tunnel deformation using a statistical analysis method of grey relational analysis-entropy evaluation method, sorting a relevancy degree of each factor to the deformation of the shallow buried unsymmetrical loading tunnel section of the tunnel to obtain main influence factors in tunnel deformation, and determining quantitative influence of each factor on tunnel deformation.

2. The multi-factor quantitative analysis method for deformation of a neighborhood tunnel according to claim 1, wherein in step 1, the monitoring content at the tunnel site comprises required monitoring items and optional monitoring items, the required monitoring items comprise observation inside and outside a tunnel, ground surface settlement, vault settlement and horizontal convergence during tunnel construction, and the optional monitoring items comprise internal force measurement for a steel arch, a seepage pressure, a surrounding rock pressure of the tunnel and axial force of an anchor bolt.

3. The multi-factor quantitative analysis method for deformation of a neighborhood tunnel according to claim 1, wherein in step 1, when the monitoring data of the tunnel site are collected, analyzed, concluded and summarized, based on an advanced geological forecast, proportions of surrounding rock at grade III, surrounding rock at grade IV and surrounding rock at grade V at a tunnel face are determined, and mechanism summarization and characteristic analysis are conducted with tunnel deformation data of the surrounding rock at different grades to determine different deformation stages of surrounding rock of a tunnel.

4. The multi-factor quantitative analysis method for deformation of a neighborhood tunnel according to claim 1, wherein the deformation stages of surrounding rock of a tunnel are classified into a growth stage and a stabilization stage, and the growth stage is divided into a rapid growth stage and a slow growth stage.

5. The multi-factor quantitative analysis method for deformation of a neighborhood tunnel according to claim 1, wherein in step 2, a whole process of tunnel construction is reproduced using the finite element numerical simulation software, three-dimensional inversion of a collapse accident occurring during tunnel construction is carried out, and in combination with data simulation and cause analysis, a whole process of tunnel deformation and surrounding rock failure accompanying the tunnel collapse is determined.

6. The multi-factor quantitative analysis method for deformation of a neighborhood tunnel according to claim 1, wherein in step 3, the factors affecting tunnel deformation and surrounding rock instability comprise an over-excavation height, a displacement distance of a face and an elastic modulus of surrounding rock, and different gradients are set for the over-excavation height, the displacement distance of a face and the elastic modulus of surrounding rock when analysis is conducted according to a control variate method.

7. The multi-factor quantitative analysis method for deformation of a neighborhood tunnel according to claim 1, wherein in step 3, said determining the degree of influence of each factor on the tunnel and the stratum specifically comprises taking ground surface settlement, a middle rock wall between the neighborhood tunnel and tunnel deformation as a judgment basis, obtaining deformation curves under different working conditions, extracting and summarizing data of ground surface deformation and tunnel deformation to obtain rules of responses of different factors to the tunnel and stratum, and obtaining characteristic values of each factor.

8. The multi-factor quantitative analysis method for deformation of a neighborhood tunnel according to claim 1, wherein in step 4, said conducting deformation-related quantitative calculation specifically comprises taking tunnel vault deformation and horizontal convergence as a judgment basis, calculating to obtain a relevancy degree of each factor to the tunnel deformation, and sorting the relevancy degree in a descending order.
